(19) United States
(12) Patent Application Publication
(10) Pub. No.: US 2003/0118788 A1
(43) Pub. Date: Jun. 26, 2003

(54) Latex-based barrier for surface coverings

(76) Inventors: Robert Pearce, Montreal (CA); Rene Menard, Cowansville (CA); Victor Caldas, Cowansville (CA); Claude Charest, St-Bruno de Montarville (CA)

Correspondence Address: Norris, McLaughlin & Marcus, P.O. Box 1018, Somerville, NJ, 08876-1018, US

(21) Appl. No.: 10/029,600

(22) Filed: Dec. 21, 2001

(51) Int. Cl. B32B 27/14

(52) U.S. Cl. 428/195

(57) ABSTRACT

The invention concerns a barrier composition, surface covering products incorporating a barrier layer, methods for making such surface covering products and methods for inhibiting or preventing the migration of sub-surface stains to the decorative portions of the surface covering products. The barrier composition comprises thermoplastic latex. The barrier composition is applied to the lower surface of the substrate of a decorative surface covering, or the lower surface of a basecoat on the substrate, and is then heat cured to obtain the barrier layer.

### BACKGROUND OF INVENTION

1. Field of the Invention

The invention involves a stain barrier and surface covering products incorporating a barrier layer comprising thermoplastic latex applied to the lower surface of a substrate or basecoat of a decorative surface covering, and processes for making such product. The barrier layer protects decorative portions of the surface covering by inhibiting or preventing stains migrating from the sub-surface to the upper layers or decorative portions of the surface covering, e.g. bottom-up staining in the case of floor coverings.

2. The Prior Art

Floor covering and wall covering materials frequently are applied over surfaces which have been coated or marked with substances such as sealants, wood stain, ink from marking pens, asphalt, oil based paints and the like, as well as colored wood extractives, microorganisms, adhesives and the like. These substances can migrate or diffuse into the floor or wall covering and cause staining of the decorative portion. Migration of the stain through the various layers of the product leads to aesthetically objectionable color changes in the upper layers or decorative portion of the product and masking of the decorative patterns.

Substances, such as organic substances, can cause staining of a variety of floor and wall coverings such as carpeting, sheet vinyl flooring, and cloth or vinyl wall coverings. Sheet vinyl flooring and wall covering products are particularly vulnerable because they contain plasticizers which are compatible with organic substances. The stains thereby diffuse into the floor or wall covering by means of the plasticizer as a vehicle. The higher the plasticizer content, normally, the faster the stain diffuses.

Recently, barrier layers have been incorporated into surface coverings to inhibit or prevent bottom-up staining. For example, U.S. Pat. Nos. 5,308,694 and 5,460,855 describe the use of a plastisol incorporating sodium silicate. U.S. Pat. Nos. 5,981,058 and 5,891,294 involve barrier layers comprising polyurethane dispersions and polyamides, with the barrier layer preferably disposed above a basecoat or substrate layer.

A drawback encountered with the use of certain polymeric barrier materials in decorative surface coverings is their susceptibility to penetration followed by attack and/or swelling by certain components which are inherent to the formulations used to manufacture these coverings. For example, the high level of low molecular weight plasticizers (e.g. dioctyl adipate, dioctyl phthalate, butyl benzyl phthalate) and diluents (e.g. TXIB, DDB) used in PVC-based resilient floor coverings can place severe limitations on the type of stain barrier material used if the barrier is in contact with those portions of the product comprising these plasticizers. Penetration of plasticizers into the barrier layer can severely compromise the performance of the barrier by essentially establishing channels in the barrier layer through which mobile stainants can migrate.

One approach to the use of polymeric materials in a barrier layer in contact with a plasticizer-containing layer is to use barrier materials having crosslinking. However, this also has drawbacks, including reduced adhesion to other layers in the product, brittleness and cost. Reduced adhesion of cross-linked systems can be overcome by corona treatment of the surface or use of coupling layers as would be understood by one skilled in the art, however, this adds an additional processing step, which is undesired in this situation.

It was an object of the invention to develop a barrier composition and barrier layer for use in surface coverings that eliminates the drawbacks associated with the use of polymeric barriers and plasticizers in the product.

It was a further object of the invention to develop a barrier composition that can be applied in the form of a barrier layer without chemical modification, such as crosslinking, yet not interact with plasticizers.

It was yet another object of the invention to develop a barrier layer that can be applied as a coating to the underside of the substrate layer or basecoat of a surface covering such that the barrier layer is between the sub-surface and the substrate or basecoat layer of the surface covering.

These and other objects of the invention are achieved by the barrier composition and barrier layer described herein comprising thermoplastic latex applied to the underside of the substrate or basecoat of the decorative surface covering. During heating steps of prior processes for making surface coverings, the barrier layer shall not come into contact with portions of the product comprising plasticizer which circumvents the problems in the art. The thermoplastic latexes have good flexibility and adhesion to most substrates, which enable the barrier material to be applied to a wide variety of substrates or backing material.

In the present Specification, all parts and percentages are on a weight/weight basis unless otherwise specified.

### SUMMARY OF THE INVENTION

The invention concerns a barrier composition and barrier layer, and surface covering products incorporating the barrier layer. The barrier composition comprises thermoplastic latex, particularly acrylic latexes. The barrier composition is applied to the lower surface of the substrate or basecoat of a decorative surface covering and then is heat cured to obtain the barrier layer.

The barrier layer protects decorative portions of the surface covering by inhibiting or preventing stains migrating from the sub-surface to the upper layers or decorative portions of the surface covering, e.g. bottom-up staining in the case of floor coverings. The barrier composition and layer will inhibit or prevent the migration of both inorganic and organic stains, and the term “stain” when used in this Specification refers to any type of stain. However, the barrier composition and layer is particularly useful to inhibit or prevent migration of organic stains. The barrier layer is compatible with conventional adhesives used to secure the surface covering to the sub-surface, e.g. the sub-floor or wall. Accordingly, the barrier layer is applied to the lower surface of the substrate layer or basecoat of the surface covering such that the barrier layer is juxtaposed directly with the sub-surface. Also, the barrier compositions of the invention tend to be less expensive than other barrier formulations in the art and, thus, the barrier layer of the present invention results in a cost savings compared to conventional barrier layers for decorative surface coverings.

Surface covering products comprising the barrier layer may be made by methods that would be known to one skilled in the art, and the barrier composition may be applied at any point in the process for making the surface covering. The application of the barrier coat at the final stage of processing is advantageous in regards to avoiding the development of excessive yellowing of the coating. The application of the barrier coat at the final stage of processing limits exposure of the barrier coat formulation during fusion to excessive plasticizers arising from both the plastisol formulations used in upper layers of the surface covering as well as from the oven environment (e.g. fumes). Also, limiting plasticizer contact with the barrier layer before the film is formed will improve barrier efficiency.

### DESCRIPTION OF THE DRAWINGS

FIG. 1 is a fragmentary sectional view through a floor covering material of the invention having a basecoat. In this view it is not intended that the thickness of the various layers of components shown or sizes of the particles are precisely represented. Rather, the various layers are represented on a considerably enlarged scale and without showing precise relationships between the thickness of the various layers or the sizes of the foam cells.

FIG. 2 is a fragmentary sectional view through a floor covering material of the invention having no basecoat. In this view it is not intended that the thickness of the various layers of components shown or sizes of the particles are precisely represented. Rather, the various layers are represented on a considerably enlarged scale and without showing precise relationships between the thickness of the various layers or the sizes of the foam cells.

### DETAILED DESCRIPTION OF INVENTION

The invention concerns a barrier composition, and a barrier layer formed from the composition and incorporated into a surface covering material, comprising thermoplastic latex, such as latexes selected from the group consisting of acrylic, acrylic styrene, vinyl acetate, vinyl acetate-co-vinyl chloride, vinyl acetate-co-ethylene, vinyl chloride-co-ethylene and the like, and combinations thereof. The preferred thermoplastic latexes are acrylic latexes. The barrier composition is applied to the lower surface of the substrate of a decorative surface covering, such as resilient floor covering, to form a barrier layer following drying and curing. The barrier layer is situated between the sub-surface, e.g. subfloor, and the substrate, such as felt or PVC, or a basecoat.

The barrier layer can be employed with any floor or wall covering material including wall paper, wall cloths, vinyl wall covering, carpeting and vinyl floor covering, as long as it can be sufficiently adhered thereto or incorporated therein. The barrier layer is particularly suited to sheet vinyl floor and wall covering materials because it is compatible with and is easily adhered to vinyl materials and to the substrate materials which typically are employed in the manufacture of sheet vinyl materials. Moreover, the barrier layer is compatible with conventional adhesives used to secure the surface covering to the sub-surface, e.g. the sub-floor or wall, and the barrier layer is applied to the lower surface of the substrate layer or basecoat such that the barrier layer is between the substrate or the basecoat and the sub-surface.

Thermoplastic latexes useful for the invention encompass all latexes containing as their principal dispersed phase homopolymers and/or copolymers containing acrylic and/or acrylate functional groups, as well as alkyl and aryl-substituted acrylic and acrylate homopolymers and copolymers, such as those manufactured from methyl methacrylate, methyl ethacrylate and analogous monomers. Acrylic styrene latexes useful in the invention encompass all latexes containing as their principal dispersed phase copolymers containing the aforementioned functionalities and styrene. Vinyl acetate latex, vinyl acetate-co-vinyl chloride latex and vinyl acetate-co-ethylene latex useful in the invention encompasses, respectively, all latexes containing as their principal dispersed phase homopolymers and/or copolymers manufactured from vinyl acetate, vinyl acetate and vinyl chloride, and vinyl acetate and ethylene. Vinyl chloride-co-ethylene latex encompasses all latexes containing as their principal dispersed phase copolymers manufactured from vinyl chloride and ethylene.

The barrier composition comprises from about 90% to 100%, preferably from about 95% to 100%, thermoplastic latex. In addition the barrier composition may comprise up to about 5%, preferably from about 0.1% to about 5%, processing aids including those selected from the group consisting of defoamer, associative thickener, wetting agents and the like, and combinations thereof.

The selection of processing aids in the barrier composition is a function of the application method as would be understood by one skilled in the art. The barrier composition may further comprise additives such as biocides, pigment and fillers. The barrier composition may consist essentially of the thermoplastic latex and optional processing aids in the amounts of about 95% to 100% thermoplastic latex and up to about 5% processing aids.

The processing aids present in the formulation obtain a uniform film thickness across the surface that the barrier coat is applied to. For example, the thickener is present to minimize absorption of the formulation by the felt-backing composition and thus produce a uniform and controlled film deposit onto the backing surface, e.g. the lower surface of the substrate layer. The need for a thickener in the barrier compositions is dependent on the surface that the barrier coat is being applied to. A vinyl-backing surface covering, for example, does not require the inclusion of a thickener because vinyl-backing surface covering will not absorb the barrier composition during or after application.

Any defoamer acceptable for use in surface coverings may be used in the barrier compositions. Preferred defoamers are any mineral oil or silicone based defoamer that may or may not contain a hydrophobic particle, such as BYK® 035 available from Byk Chemie USA Inc., Wallingford, Conn., USA (“Byk Chemie”). The defoamer may be present in the composition in amounts up to about 3%, preferably from about 0.05% to about 3% and most preferably from about 0.05% to about 1%.

The associative thickener may be any thickening compound comprising urethane, cellulosic-based thickeners or any amine swellable thickener. Combinations of such associative thickeners may be used. In the case of the amine swellable thickener, the pH of the formulation must be adjusted to above 7, which may be adjusted by using any base. Preferably, however, the pH is adjusted by using concentrated aqueous ammonium hydroxide at a concentration between about 0.1% to about 2%, preferably having a concentration of about 0.2%. The preferred thickener is Carbopol EP-2, which is an amine swellable thickener available from B. F. Goodrich, Charlotte, N.C., USA. The barrier composition may comprise from about 0.1% to about 3% associative thickener, preferably between about 0.5% to about 1.5%.

Any neutral, non-ionic, cationic and/or anionic wetting agent having a polar and non-polar component may be used in the barrier composition. The amount and type of wetting agent depends on the substrate and/or film formation requirements. Up to about 3%, preferably from about 0.2% to about 2.5%, wetting agents may be included in the barrier composition.

A preferred barrier composition comprises about 99% of an acrylic latex available from B. F. Goodrich under the tradename HYCAR® 26138, diluted up to about 50%, preferably diluted by about 10% for about a 45% solids content of the formulated barrier composition, about 0.05% BYK® 035 defoamer, about 0.5% Carbopol EP-2 thickener and about 0.2% concentrated aqueous ammonium hydroxide. The ammonium hydroxide is required to raise the system pH above 7 and activate the thickener. As an alternative to concentrated ammonium hydroxide, a solution of about 10% aqueous sodium hydroxide can be used, at an addition level of about 0.3%.

While the principles of the invention are applicable to various floor and wall covering materials, the preferred embodiment will be described herein with reference to sheet vinyl floor coverings. The principles disclosed can be applied by those skilled in the art to other floor and wall covering materials.

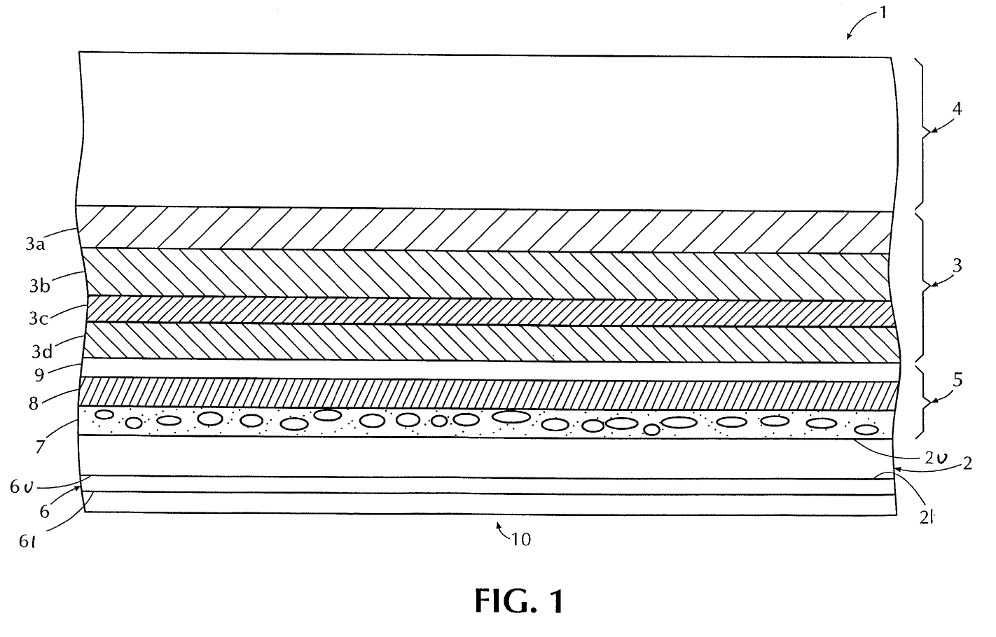

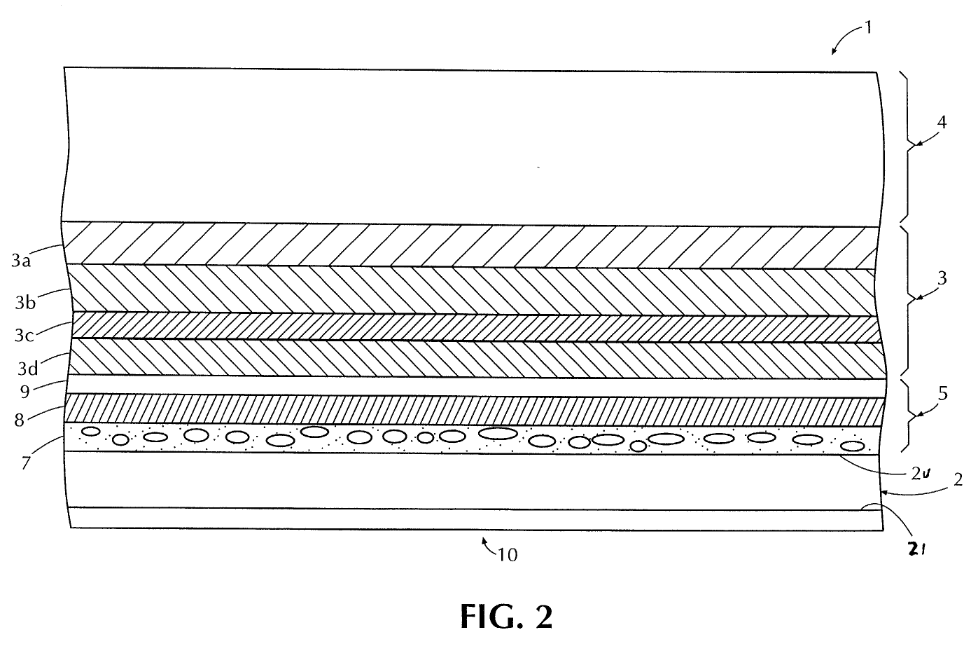

Now referring to FIGS. 1 and 2 which depict general sheet vinyl floor covering materials 1, sheet vinyl floor covering materials are generally comprised of a substrate 2, having an upper surface 2u and lower surface 2l, overlayed by a decorative portion 3 comprising one or more layers, (3a, 3b, 3c, 3d), and one or more wear layers 4. The substrate 2, generally felt, plastisol or urethane materials, or calandered PVC sheet, can be overlaid, optionally, with one or more latex and/or plastisol layers 5 before application of the decorative portion. As shown in FIG. 1, the substrate also can, optionally, be undercoated with a basecoat 6 comprising one or more latex and/or plastisol layers.

In the embodiment of the invention illustrated in FIG. 1, the basecoat 6 having an upper surface 6u and a lower surface 6l is applied to the substrate 2, such that the upper surface 6u of the basecoat 6 interfaces, is juxtaposed, with the lower surface 2l of the substrate 2. The barrier composition is applied to the lower surface 6l of the basecoat to form the barrier layer 10 on the lower surface 6l of the basecoat 6. FIG. 2 shows an embodiment where the sheet vinyl floor covering material 1 has no basecoat and the barrier layer 10 interfaces, is juxtaposed, with the lower surface 2l of the substrate 2. It is understood that the various layers of the sheet vinyl floor covering materials 1 are laminated to each other.

Referring to FIGS. 1 and 2, decorative elements of floor covering can include embossing, by chemical or mechanical means or combinations thereof, pigments, dyes, printing inks and particulate matter, such as chips, flakes, pearls and the like. These decorative elements can be used alone, or two or more can be combined in various ways, to achieve desired decorative effects. For example, the decorative portion may comprise a first printed layer 3d in the form of a pattern or design, a preferably clear adhesive layer 3c which is normally a plastisol or organosol additionally containing a plasticizer system, associated dilutents, viscosity control aids and stabilizers, a preferably transparent smooth coat layer 3b comprising materials similar to those used in the adhesive layer 3c and a second printed layer 3a comprising materials similar to that of the first printed layer 3d. It is also possible to include decorative elements in more than one layer of the floor covering. Certain portions of decorative elements, or the layers embodying them, might not be visible from above the installed floor covering. For example, the latex or plastisol layer 5 may comprise a chemically blown layer 7 which causes the floor covering to have an embossed effect and can be located below layers which are opaque, such as an opaque printed layer 8. Moreover, the latex or plastisol layer 5 may comprise portions of pigmented layers or printing inks 9 which might not be visible from the upper surface and thus, are not considered part of the decorative portion of the surface covering material. Accordingly, the term “decorative portion(s)” as used in this Specification means the visible portion of the decorative elements, and the object of the invention is to avoid the migration of stains into such visible portions.

Numerous constructions for sheet vinyl floor covering materials are known in the art in addition to those enumerated above. They share as a common characteristic, however, a layered construction to which the principles of this invention are easily applied.

In the manufacture of sheet vinyl floor covering materials, a substrate is employed as a carrier for the vinyl and decorative elements. The substrate is a relatively flat, fibrous or non-fibrous, backing sheet material, such as a fibrous, felted or matted, relatively flat sheet or overlapping, intersecting fibers. The substrate can comprise felts or papers which are woven or non-woven. It can comprise knitted or otherwise fabricated textile material or fabrics made from cellulose, glass, natural or synthetic organic fibers, or natural or synthetic inorganic fibers, or supported or non-supported webs or sheets made therefrom, or filled or unfilled thermoplastic or thermoset polymeric materials. The substrate may be calandered PVC sheet. These and other substrate materials are well known in the art and need not be further detailed here.

Various layers which can be applied directly to the substrate include those discussed above, as well as latexes, plastisols and foamable plastics which can be pigmented or be free of pigmentation. Plastisol inks with or without foaming agents also can be applied.

The barrier composition is applied to the lower surface of the substrate or basecoat and cured. The barrier composition is substantially uniformly applied in its wet state by conventional means such as a knife-over roll coater, direct roll coater, rotary screen, drawdown bar, reverse roll coater, air-knife application method or wire wound bar (Myer rod). The particular means for applying the composition does not relate to the essence of the invention, and any suitable coating means can be employed.

The barrier composition may be applied to the substrate or basecoat at any point in the manufacturing process. However, it is preferably applied at the final stage of manufacture, following completion of the rest of the product. This avoids excessive yellowing of the barrier layer due to repeated exposure to the high temperatures typically used in manufacturing surface coverings. In addition, application of the barrier composition at the final stage of processing limits exposure of the barrier composition during fusion to excessive plasticizers and also limits exposure to fumes in the oven. Also, limiting plasticizer contact with the barrier layer before the film is formed is found to improve barrier efficiency.

The thickness of the barrier layer is substantially uniform and from about 0.1 mil to about 10 mil (wet), preferably from about 1 mil to about 3 mil (wet) which corresponds to about 0.45 mil to about 1.3 mil (dry) after curing, and can be thicker or thinner as may be the particular product application. After the barrier composition is applied, the combination of barrier composition, substrate or basecoat and other layers, if applicable, are heated for a period of time and at a temperature sufficient to evaporate water and gel or fuse the barrier composition. Heating of the combination comprising the barrier composition can be carried out in an oven. Other means of heating the combination comprising the barrier compostion include infra-red heating combined with air pulse of the barrier coat. The heating may be performed in conjunction with microwave evaporation of the water in the formulation. Heating conditions will vary depending on the additives and resins used as will be apparent to those skilled in the art. Heating in an oven is preferred, and if an oven is used, the surface covering comprising the barrier composition is heated for a residence time in the oven of from about 5 seconds to about 2 minutes and 30 seconds at an oven temperature from about 200° C. to about 50° C., preferably from about 100° C. to about 60° C. for a residence time of about 10 seconds to about 30 seconds. Following heating or drying, the combination, optionally, can be cooled.

The barrier layer must be compatible with both the substrate or basecoat material and adhesives used to secure the surface covering to the sub-surface. The application of the latex barrier underneath the surface covering necessitates that adhesion of the product to the sub-surface, e.g. subfloor, not be compromised. The barrier layer of the invention does not affect the adhesion properties of conventional adhesives used for felt-backed surface coverings, such as Domco 202 and Tarkett FB1 adhesives available from Domco Tarkett Inc., Farnham, Quebec, Canada.

The barrier layer should be sufficiently flexible so as not to crack during the winding-up process and during installation. The barrier layer passes a 1″ mandrel flexibility test when applied at a thickness of 1 mil (dry) on a felt-based product having a total thickness of 80 mil.

In addition to the processing previously discussed, the barrier composition may further comprise additives selected from the group consisting of biocides, pigments, fillers, and the like and combinations thereof. For example, biocides may be appropriate in applications where discoloring due to microorganism growth in, and migration from, a surface below the product is possible. The biocide may also be beneficial in extending the storage life of the barrier composition prior to its application.

### EXAMPLES

In order to demonstrate the stain-blocking properties of the latex-based barrier composition and barrier layer, two test procedures were employed, as described below.

### Procedure 1

A stainant solution comprising 0.5% Yellow Dye dissolved in VARSOL® is used. The Yellow Dye is available from DuPont, Wilmington, Del., USA, and the VARSOL® is available from the Exxon Mobil Chemical Company, Houston, Tex., USA. Small square samples covering about 2 inches by 2 inches are cut from the surface covering to be tested and are placed face-down on a glass plate, such that the barrier layer is facing up. A small piece of felt or filter paper, measuring approximately 1 inch by 1 inch is placed on top of the samples (in contact with the barrier layer). Using an eye dropper, five drops of the stainant solution described above are placed on each piece of felt or filter paper. A small cylindrical cap (½ inch diameter and ¼ inch in height) is placed over each stain and a glass plate is placed over the caps. These are placed in an oven set at 70° C. At time intervals, the samples are removed from the oven and their Yellow Index (YI) is measured on the side opposite to the barrier layer using a reflectance spectrophotometer (model CM-508d available from Minolta USA, Inc. (“Minolta”), Ramsey, N.J., USA).

### Procedure 2

Small disks of wood measuring about 1.5 inches in diameter and 0.25 inches in thickness are impregnated with 0.2 ml of the stainant solution described in Procedure 1 by dispensing this amount onto the top surface using a pipette. The wooden disks are heated in an oven for 90 minutes at a temperature of 100° C., and then allowed to cool. After cooling to room temperature, adhesive, either Domco 202 or Tarkett FB1 as appropriate in accordance with manufacturers specifications, is applied onto the stained surface of the wooden disks and spread using a trowel in an amount of adhesive sufficient to cover the entire surface. The adhesive is applied in accordance with the instructions and recommendations of the adhesive manufacturer, particularly with regards to quantity, open-time and set-time. After the recommended open-time has elapsed, small samples of surface coverings to be tested, measuring about 2 inches by 2 inches are pressed onto the adhesive-covered disks and the covered disks are then placed between two glass plates. After the recommended set-time has elapsed, the samples (e.g. surface covering adhered to the stained wooden disks) are placed in an oven set to 70° C. At time intervals, samples are removed from the oven and their YI is measured on the side of the sample opposite to the wooden disk using a reflectance spectrophotometer (model CM-508d available from Minolta).

### Example 1

A vinyl floor covering sample comprising the barrier layer was made by first applying 10 mil of nonfoamable plastisol to 30 mil felt substrate and gelling the nonfoamable plastisol in an oven at 200° C. for 1.5 minutes in a horizontal position. Then, 18 mil of foamable plastisol was applied to the nonfoamable plastisol and the sample was gelled in an oven at 200° C. for 1 minute in a horizontal position. 20 mil of a nonfoamable wearlayer plastisol was then applied on top of the foam layer and the sample was heated in an oven for 1 minute at 200° C. in a horizontal position. No print was done on this foamable plastisol as this Example is just for testing the barrier properties. The sample was then heated in an oven at 200° C. for 1 minute and 55 seconds in a vertical position with rotation in order to expand the foam, yielding an overall sample thickness of approximately 80 mil. Using Myer rod number 22, about 2 mil of the barrier composition set forth in Table I was applied to the lower surface (felt side) of the substrate. After applying the barrier composition, the sample was heated in an oven at temperatures from about 200° C. to about 60° C. for a residence time of about 13 seconds for about 2 minutes in a horizontal position, yielding a dry barrier layer thickness of approximately 1 mil.

TABLE 1

| | |
|---|---|
| HYCAR ® 26138 (BF Goodrich), diluted to 45% solids | 99.25% |
| Carbopol EP2 (BF Goodrich) | 0.5% |
| BYK ® 035 (Byk Chemie) | 0.05% |
| Concentrated Ammonium Hydroxide | 0.2% |

The sample, denoted “DT Barrier EX 1”, was then stain tested according to Procedure 1. For comparison, a floor covering made by the above procedure except without application of the barrier composition and subsequent heating, denoted “DT No Barrier EX 1”, was tested in accordance with Procedure 1, as well as samples of three commercially available floor covering products, which are Mannington iBACK® (from Mannington Mills Inc., Salem, N.J., USA), Congoleum ULTIMA® (from Congoleum Corporation, Mercerville, N.J., USA) and ARMSTRONG TOUGH GUARD® (from Armstrong World Industries, Inc., Lancaster, Pa., USA). Results of the stain testing are shown in Table 2 below, expressed in terms of YI as a function of residence time at 70° C.

TABLE 2

| | YI | | |
|---|---|---|---|
| Product | (20 hours) | YI (24 hours) | YI (40 hours) |
| DT Barrier EX 1 | 12.8 | 13.5 | 26.6 |
| DT No Barrier EX 1 | 25.3 | 29.6 | 93.7 |
| MANNINGTON iBACK ® | 14.8 | 20.8 | 43.0 |
| Congoleum ULTIMA ® | 3.2 | 12.0 | 22.8 |
| ARMSTRONG TOUGH | 18.0 | 20.8 | 46.9 |
| GUARD ® | | | |

### Example 2

Floor covering material made in accordance with the materials and procedure described in Example 1 was prepared. Samples were then made and tested in accordance with Procedure 2. The test sample is denoted “DT Barrier EX 2”. For comparison, a floor covering made by the procedure of Example 1 except without application of the barrier composition and subsequent heating was made and a sample of it was prepared and tested in accordance with Procedure 2. This comparative sample is denoted “DT No Barrier EX 2”. Also, samples of three commercially available floor covering products, which are MANNINGTON iBACK®, Congoleum ULTIMA® and ARMSTRONG TOUGH GUARD® were prepared and tested in accordance with Procedure 2. The results are shown in Table 3, below, expressed in terms of YI as a function of residence time at 70° C.

TABLE 3

| | YI | | |
|---|---|---|---|
| Product | (30 hours) | YI (50 hours) | YI (70 hours) |
| DT Barrier EX 2 | 12.4 | 14.1 | 16.0 |
| DT No Barrier EX 2 | 12.6 | 16.3 | 21.5 |
| MANNINGTON iBACK ® | 25.3 | 29.9 | 41.2 |
| Congoleum ULTIMA ® | 14.0 | 16.5 | 20.3 |
| ARMSTRONG TOUGH | 4.2 | 8.1 | 22.7 |
| GUARD ® | | | |

### Example 3

Floor covering material comprising a barrier layer was made by first applying 16 mil of foamable plastisol on a substrate of 20 mil fiberglass sheet pre-saturated with nonfoamable plastisol and heating in an oven at 200° C. for 1 minute in a horizontal position to gel the foamable plastisol. Then, 18 mil of a nonfoamable wearlayer was applied to the foam layer and the sample was then gelled by heating in an oven for 1 minute at 200° C. in a horizontal position and then for 1 minute and 55 seconds in a vertical position with rotation in order to expand the foam. 10 mil of a nonfoamable basecoat was then applied to the side of the sample opposite to the foam and the sample was again heated in an oven for 1 minute at 200° C. in a horizontal position. Using a Myer rod number 22, about 2 mil of the barrier composition described in Example 1 was applied to the nonfoamable basecoat, and the entire sample was heated in an oven for 2 minutes at 200° C. in a horizontal position. The final sample thickness was about 70 mil.

The sample, denoted as “DT Barrier EX 3”, was then stain tested according to Procedure 1. For comparison, a floor covering made by the above procedure except without application of the barrier composition and subsequent heating, denoted “DT No Barrier EX 3”, was tested in accordance with Procedure 1, as well as samples of three commercially available floor covering products, which are MANNINGTON iBACK®, Congoleum ULTIMA® and ARMSTRONG TOUGH GUARD®. The results are shown in Table 4, below, expressed in terms of YI as a function of residence time at 70° C.

TABLE 4

| | YI | | |
|---|---|---|---|
| Product | (20 hours) | YI (24 hours) | YI (40 hours) |
| DT Barrier EX 3 | 13.7 | 14.9 | 34.6 |
| DT No Barrier EX 3 | 16.5 | 17.5 | 40.3 |
| MANNINGTON iBACK ® | 35.3 | 38.7 | 70.9 |
| Congoleum ULTIMA ® | 24.7 | 29.3 | 36.2 |
| ARMSTRONG TOUGH | 46.6 | 49.8 | 73.4 |
| GUARD ® | | | |

### Example 4

Separate floor coverings with felt substrate and a barrier layer comprising latexes of vinyl acetate, acrylic styrene, vinyl acetate-co-vinyl chloride, vinyl acetate-co-ethylene and vinyl chloride-co-ethylene were prepared by first applying 16 mil of foamable plastisol on a 25 mil felt and then heating in an oven at 200° C. for 1 minute in a horizontal position to gel the foamable plastisol. Next, 18 mil of a nonfoamable wearlayer was applied to the foam layer and the sample was gelled by heating in an oven for 1 minute at 200° C. in a horizontal position and then for 1 minute and 55 seconds in a vertical position with rotation in order to expand the foam. Using a Myer rod number 22, approximately 2 mil of the following latexes were applied to the lower surface of the substrate of the respective floor covering materials opposite to that with foam, such that each respective floor covering had a different barrier layer: vinyl acetate latex (AIRFLEX® 192 available from Air Products and Chemicals, Inc., Allentown, Pa., USA), acrylic styrene latex (JONCRYL® 530 and SCX 1925 available from Johnson Polymers, Inc. Sturtevant, Wis., USA), vinyl acetate-co-vinyl chloride latex (AIRFLEX® 4500, AIRFLEX® 4514 available from Air Products and Chemicals, Inc.), vinyl acetate-co-ethylene latex (AIRFLEX® 108 available from Air Products and Chemicals, Inc.), and vinyl chloride-co-ethylene latex (VANCRYL® 600, available from Air Products and Chemicals, Inc.). In each case, the floor covering was heated for 2 minutes at 200° C. in a horizontal position after application of the barrier composition. The final sample thickness of each floor covering was about 70 mil.

Samples of each floor covering material having a barrier layer comprising the different thermoplastic latexes discussed above were prepared and stain tested in accordance with Procedure 1. Each sample is denoted by the type of thermoplastic latex barrier layer pertinent to that sample. For comparison, a floor covering made by the above procedure except without application of any barrier composition and subsequent heating, denoted “DT No Barrier EX 4”, was tested in accordance with Procedure 1. The results are shown in Table 5, below, expressed in terms of YI as a function of residence time at 70° C.

TABLE 5

| | YI | YI | YI |
|---|---|---|---|
| Product | (20 hours) | (24 hours) | (40 hours) |
| Vinyl Acetate Barrier | 12.5 | 15.4 | 27.5 |
| (AIRFLEX ® 192) | | | |
| Acrylic Styrene Barrier | 14.0 | 15.6 | 27.6 |
| (JONCRYL ® 530) | | | |
| Acrylic Styrene Barrier (SCX 1925) | 14.7 | 18.9 | 31.0 |
| Vinyl Acetate-co-Vinyl Chloride | 12.4 | 16.6 | 39.4 |
| Barrier (AIRFLEX ® 4500) | | | |
| Vinyl Acetate-co-Vinyl Chloride | 13.3 | 18.7 | 37.3 |
| Barrier (AIRFLEX ® 4514) | | | |
| Vinyl Acetate-co-Ethylene Barrier | 13.8 | 15.8 | 31.1 |
| (AIRFLEX ® 108) | | | |
| Vinyl Chloride-co-Ethylene Barrier | 14.7 | 20.0 | 36.0 |
| (VANCRYL ® 600 | | | |
| DT No Barrier EX 4 | 47.1 | 52.4 | 64.5 |

What is claimed is:

1. A barrier layer which is part of a surface covering having at least a substrate with a lower surface, a decorative portion and the barrier layer which inhibits or prevents the migration of underlying stain into the decorative portion of the surface covering, wherein the barrier layer comprises a thermoplastic latex and is beneath the lower surface of the substrate.

2. The barrier layer of claim 1 having a basecoat with an upper surface and lower surface, the basecoat being on the lower surface of the substrate and the barrier layer being on the lower surface of the basecoat.

3. The barrier layer of claim 1 wherein the thermoplastic latex is an acrylic latex.

4. The barrier layer of claim 1 wherein the thermoplastic latex is selected from the group consisting of acrylic styrene, vinyl acetate, vinyl acetate-co-vinyl chloride, vinyl acetate-co-ethylene and vinyl chloride-co-ethylene and combinations thereof.

5. The barrier layer of claim 1 comprising from about 90% to about 100% thermoplastic latex.

6. The barrier layer of claim 5 further comprising up to about 5% processing aids.

7. The barrier layer of claim 6 wherein the processing aids are selected from the group consisting of defoamer, associative thickeners, wetting agents and combinations thereof.

8. The barrier layer of claim 7 comprising up to about 3% defoamers, about 0.1% to about 3% associative thickener and up to about 3% wetting agent.

9. The barrier layer of claim 6 further comprising ammonium hydroxide or sodium hydroxide.

10. The barrier layer of claim 1 further comprising additives selected from the group consisting of pigments, biocides, fillers and combinations thereof.

11. The barrier layer of claim 1 wherein the stain is organic.

12. A surface covering material comprising the barrier layer of claim 1.

13. A surface covering material comprising:
a) a substrate having an upper surface and a lower surface;
b) a decorative portion having one or more layers;
c) one or more wear layers; and
d) a barrier layer comprising a thermoplastic latex wherein the barrier layer is beneath the lower surface of the substrate.

14. The surface covering material of claim 13 further comprising a basecoat having an upper surface and a lower surface wherein the lower surface of the substrate is on the upper surface of the basecoat and the barrier layer is on the lower surface of the basecoat.

15. The surface covering material of claim 13 wherein the thermoplastic latex is an acrylic latex.

16. The surface covering material of claim 13 wherein the thermoplastic latex is selected from the group consisting of acrylic styrene, vinyl acetate, vinyl acetate-co-vinyl chloride, vinyl acetate-co-ethylene, vinyl chloride-co-ethylene and combinations thereof.

17. The surface covering material of claim 13 wherein the barrier layer comprises from about 90% to about 100% thermoplastic latex.

18. The surface covering material of claim 13 wherein the barrier layer further comprises up to about 5% processing aids.

19. The surface covering material of claim 18 wherein the processing aids are selected from the group consisting of defoamer, associative thickeners, wetting agents and combinations thereof.

20. The surface covering material of claim 19 wherein the barrier layer comprises up to about 3% defoamer, about 0.1% to about 3% associative thickener and up to about 3% wetting agent.

21. The surface covering material of claim 13 further comprising additives selected from the group consisting of pigments, biocides fillers and combinations thereof.

22. The surface covering material of claim 13 wherein the barrier layer has a thickness of about 0.45 mil to about 1.3 mil (dry).

23. A method for inhibiting or preventing the migration of underlying stain into the decorative portion of surface covering materials by providing a surface covering material comprising at least a substrate having an upper surface and lower surface, a barrier layer, and a decorative portion and securing the surface covering to a sub-surface wherein the barrier layer comprises a thermoplastic latex and is beneath the lower surface of the substrate.

24. The method of claim 23 wherein the thermoplastic latex is an acrylic latex.

25. The method of claim 23 wherein the thermoplastic latex is selected from the group consisting of acrylic styrene, vinyl acetate, vinyl acetate-co-vinyl chloride, vinyl acetate-co-ethylene, vinyl chloride-co-ethylene and combinations thereof.

26. A process for making a surface covering material having at least a substrate having an upper surface and a lower surface, a barrier layer formed from a barrier composition comprising thermoplastic latex, a decorative portion and, optionally, a basecoat having an upper surface and lower surface with the upper surface of the basecoat being on the lower surface of the substrate, wherein the barrier composition is applied to the lower surface of the substrate or the basecoat after all other processing steps are complete and the barrier composition is heated for about 5 seconds to about 2 minutes and 30 seconds at a temperature of about 200° C. to about 50° C. to form the barrier layer.

27. The process of claim 26 wherein the barrier composition is applied at a thickness of about 0.4 mil to about 5 mils (wet).
